(19) United States
(12) Patent Application Publication
(10) Pub. No.: US 2018/0317471 A1
(43) Pub. Date: Nov. 8, 2018

(54) FISHING APPARATUS AND METHOD

(71) Applicant: James E. McLaughlin, Bentley, LA (US)

(72) Inventor: James E. McLaughlin, Bentley, LA (US)

(21) Appl. No.: 15/970,867

(22) Filed: May 3, 2018

Related U.S. Application Data
(60) Provisional application No. 62/500,689, filed on May 3, 2017.

(51) Int. Cl. A01K 91/02; A01K 87/00

(52) U.S. Cl. CPC A01K 91/02; A01K 87/00

(57) ABSTRACT

An apparatus used for fishing; the apparatus includes an elongate member having a plurality of second contact strips, a proximal end and a distal end. The apparatus also includes a recess located on the proximal end of the elongate member. Further still, the apparatus includes a housing having an aperture, an internal motor, a plurality of buttons, and a plurality of first contact strips. The housing is configured for removable coupling with the recess. The plurality of first contact strips on the housing are configured for removable coupling with the plurality of second contact strips on the elongate member. The apparatus is useful for automating the process of delivering and retracting a fishing line from the housing.

### CROSS-REFERENCE TO RELATED APPLICATION(S)

The present application is related to and claims priority to U.S. Provisional Patent Application No. 62/500,689 filed May 3, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fishing reels of existing art and more specifically relates to automated fishing reels.

### RELATED ART

Many people enjoy fishing. Fishing is the activity of trying to catch fish. Fish are normally caught in the wild. Techniques for catching fish include hand gathering, spearing, netting, angling, and trapping. Fishing may also include catching aquatic animals other than fish, such as crustaceans and the like.

People with limited physical ability may also still enjoy fishing. Trying to reel in fishing line with a spinning handle can be difficult for the elderly and young children. People may be unable to maintain a good, strong hold on the reel in order to bring in a big catch. Children may get easily frustrated because they cannot hold the rod and reel in a fish. An efficient alternative is needed.

U.S. Pat. No. 7,073,740 to Bryan E. Westhoff relates to a motorized fishing reel actuating mechanism and rod assembly. The described motorized fishing reel actuating mechanism and rod assembly includes a support housing having a rod and reel member and a mounting member extending perpendicularly from the rod and reel member. A fishing rod is joined to and extends forwardly from a sleeve disposed in the support housing. An elongated handle is mounted a gear housing and extends rearward with respect to the support housing. An electrical motor is disposed inside the elongated handle. A power source is operatively coupled to the electrical motor and a drive train is operatively coupled to the electrical motor. A gear assembly is operatively coupled to the drive train and the fishing reel for winding a fishing line thereupon. A switch assembly includes a variable control mechanism and an elongated lever arm pivotally connected to the switch assembly. The variable control mechanism varies the speed of the electrical motor.

### SUMMARY OF THE INVENTION

In view of the foregoing disadvantages inherent in the known fishing reel art, the present disclosure provides a novel fishing apparatus and method. The general purpose of the present disclosure, which will be described subsequently in greater detail, is to provide a fishing rod and reel assembly that is capable of pulling in a fishing line at the push of a button, thereby eliminating the need to manually operate a spinning handle.

An apparatus used for fishing is disclosed herein. The apparatus may include an elongate member having a plurality of second contact strips, a proximal end and a distal end. The apparatus may also include a recess located on the proximal end of the elongate member. Further still, the apparatus may include a housing having an aperture, an internal motor, a plurality of buttons, and a plurality of first contact strips. The housing may be configured for removable coupling to the recess. The plurality of first contact strips on the housing may be configured for removable coupling with the plurality of second contact strips on the elongate member. The apparatus may be useful for automating the process of delivering and retracting a fishing line from the housing.

According to another embodiment, a method of using an automatic fishing rod is also disclosed herein. The method of using an automatic fishing rod may include providing a fishing rod having an elongate member that includes a recess and housing with a plurality of buttons, pressing a first of the plurality of buttons to cast a fishing line, and pressing a second of the plurality of buttons to retrieve the fishing line.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fishing apparatus and method, constructed and operative according to the teachings of the present disclosure.

FIG. 1 is a perspective view of the fishing apparatus during an ‘in-use’ condition, according to an embodiment of the disclosure.

FIG. 2 is a perspective view of the fishing apparatus of FIG. 1, according to an embodiment of the present disclosure.

FIG. 3 is a close-up perspective view of the fishing apparatus of FIG. 1, according to an embodiment of the present disclosure.

FIG. 4 is a side view of the fishing apparatus of FIG. 1, according to an embodiment of the present disclosure.

FIG. 5 is a flow diagram illustrating a method of using an automatic fishing rod, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to fishing reels and more particularly to a fishing apparatus and method as used to provide a fishing rod and reel assembly that is capable of pulling in a fishing line at the push of a button, thereby effectively eliminating the need to manually operate a spinning handle.

Generally, the present invention provides fishing rods with a reel housing for use capable of pulling in fishing line at the press of a button, thereby eliminating the need to manually operate a spinning handle. This allows those with arthritis, disabilities, and other physical limits to easily reel in fish. It offers a way for anglers to fish with multiple rods simultaneously without worry of missing a hooked fish. It may include an internal motor and at least one electrical contact strip which works in conjunction to reel in the line after the button is pressed. The present invention prevents young children and those with limited physical dexterity from becoming frustrated trying to reel in fishing line. The fishing apparatus of this disclosure may include a single planetary mechanism or a double planetary mechanism for additional power. Preferred embodiments may be configured primarily with the latter mechanism with the double planetary formation.

The device of this disclosure may be comprised of an electric fishing reel with an internal motor, electrical contact strips, a casting trigger, and a push button retrieval mechanism. The fishing pole can include a screw clamp, electrical contact strips, an internal battery, and a recharging port.

The electrical contact strip on the reel and rod may be configured to couple in a manner capable of delivering electrical power from the rod's internal batteries to the reel's internal motor. Users can activate the casting trigger in order to effectively throw out the line. The line can be reeled in via the push button mechanism. The automation of reeling in the line allows elderly, children, and others with limited physical ability to easily reel in a fish.

Upon reading this specification, it should be appreciated that, under appropriate circumstances, considering such issues as user preferences, design preference, structural requirements, marketing preferences, cost, available materials, technological advances, etc., other fishing apparatus arrangements such as, for example, additional housing components or grip members, etc., may be sufficient.

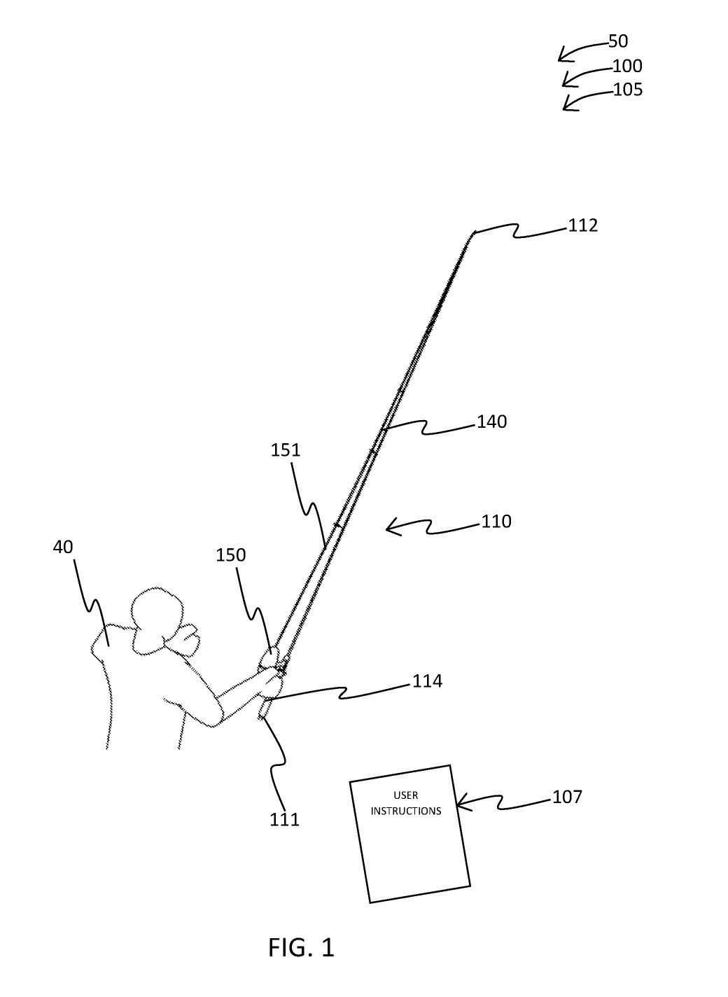

Referring now more specifically to the drawings by numerals of reference, there is shown in FIGS. 1-4, various views of an apparatus 100 used for fishing.

FIG. 1 shows the apparatus 100 used for fishing during an ‘in-use’ condition 50, according to an embodiment of the present disclosure. Here, the apparatus 100 may be beneficial for use by a user 40 to cast and pull in a fishing line at the push of a button, thereby effectively eliminating the need to manually operate a spinning handle. As illustrated, the apparatus 100 may include an elongate member 110 having a proximal end 111 and a distal end 112. As shown, the elongate member 110 may also include a first handle 114 located on at the proximal end 111. In addition, the apparatus 100 may also include a fishing rod 140 and fishing reel 150 that may be configured to cast a fishing line 151.

According to one embodiment, the apparatus 100 may be arranged as a kit 105. In particular, the apparatus 100 may further include a set of instructions 107. The instructions 107 may detail functional relationships in relation to the structure of the apparatus 100 such that the apparatus 100 can be used, maintained, or the like, in a preferred manner.

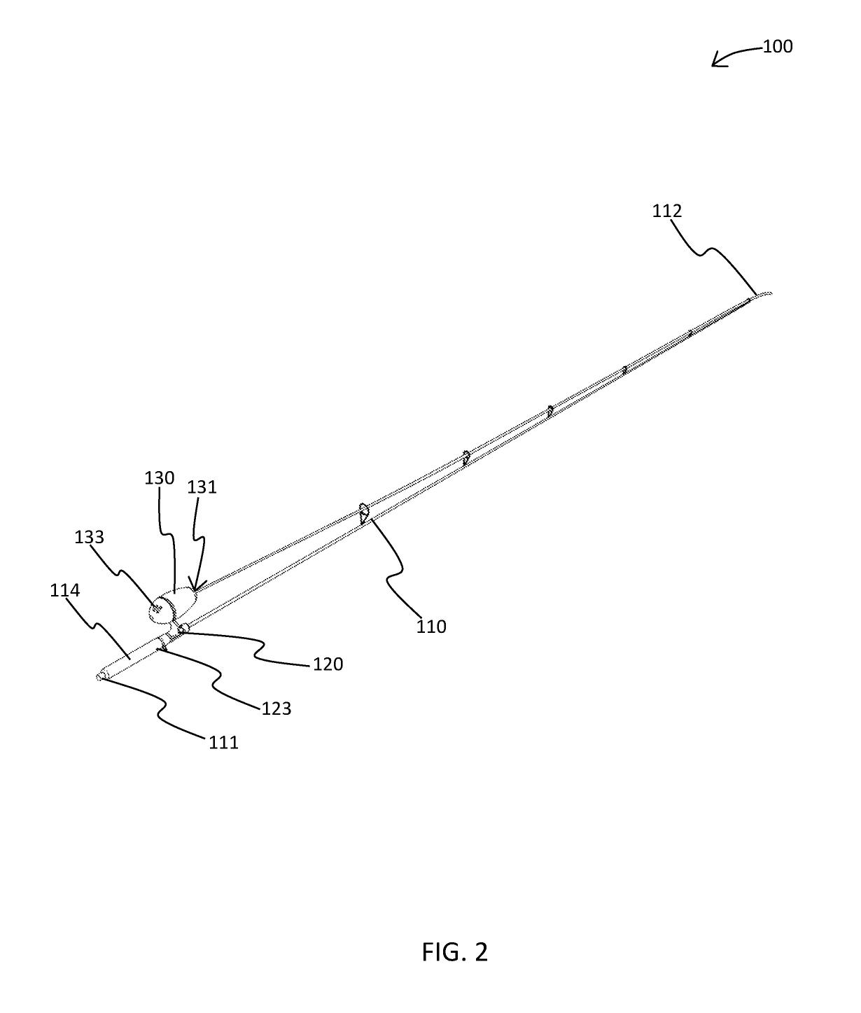

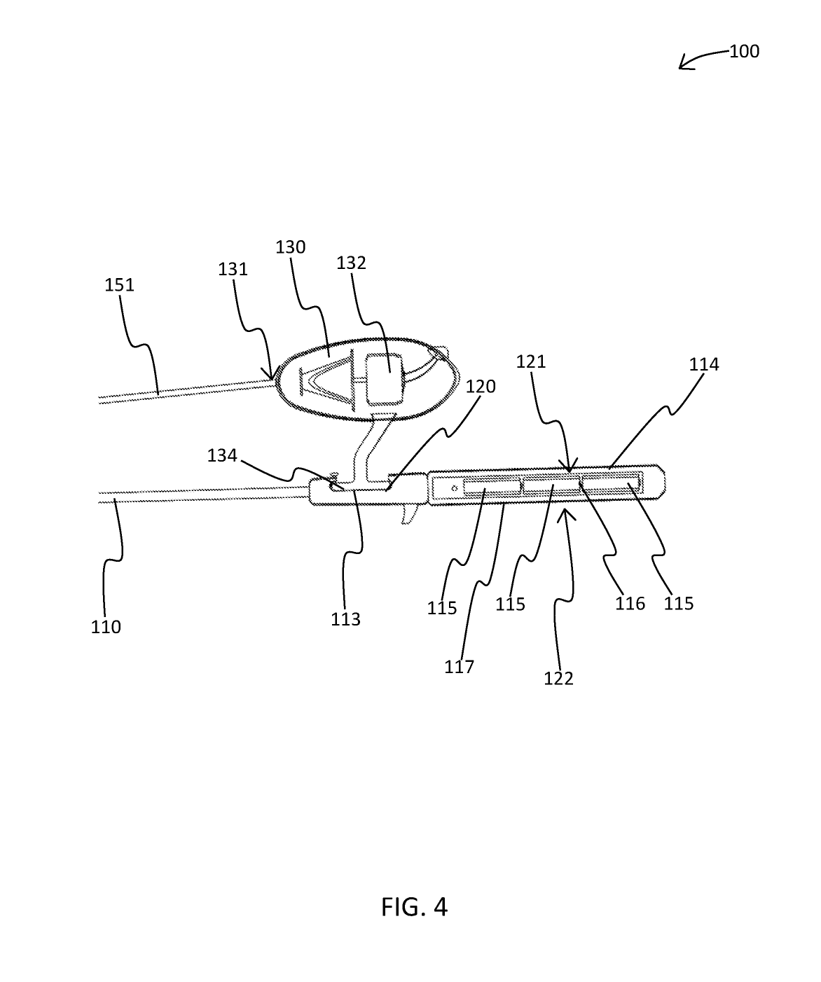

FIG. 2 shows the apparatus 100 used for fishing of FIG. 1, according to an embodiment of the present disclosure. As above, the apparatus 100 may include an elongate member 110 having a proximal end 111 with a first handle 114 and a distal end 112. The apparatus 100 may also include a recess 120 located on the proximal end 111 of the elongate member 110. The elongate member 110 may further comprise a port 123 configured to allow charging of batteries 115 (not shown here; batteries 115 first shown in FIG. 4). Further still, the apparatus 100 may include a housing 130 having an aperture 131 and a plurality of buttons 133, wherein the housing 130 may be removably coupled to the recess 120.

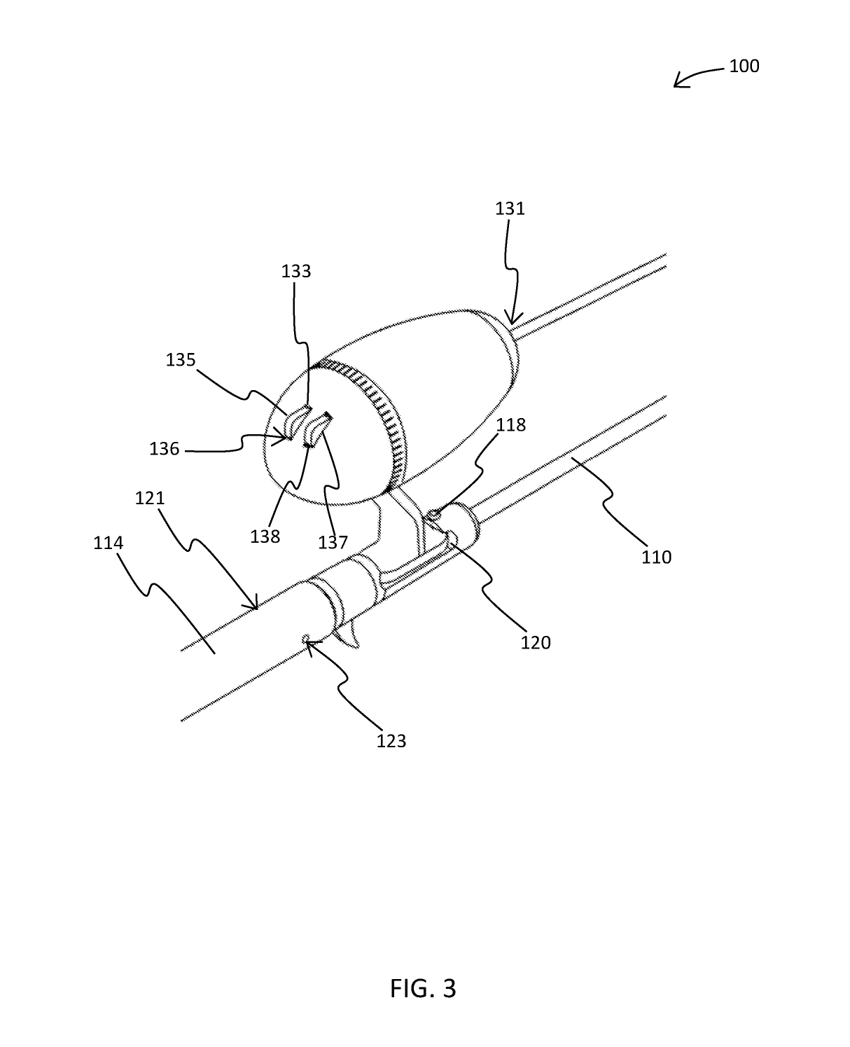

FIG. 3 is a close-up perspective view of the apparatus 100 used for fishing of FIG. 1, according to an embodiment of the present disclosure. Here again, the apparatus 100 may include an elongate member 110 having a first handle 114 and a recess 120 configured to couple with the housing 130 (not called out here; see FIG. 2). The elongate member 110 may include a screw clamp 118 for holding the housing 130 within the recess 120 located on an upper surface 121 of the elongate member 110. The elongate member 110 may further comprise a port 123. The housing 130 may include an aperture 131 and a plurality of buttons 133. The plurality of buttons 133 may comprise a first button 135 and a second button 137. The first button 135 may comprises a casting trigger 136 configured to cast a fishing line, while the second button 137 may comprise a push button 138 configured to retrieve a fishing line.

Referring now to FIG. 4, a side view of the apparatus 100 used for fishing of FIG. 1, according to an embodiment of the present disclosure. As above, the apparatus 100 may include an elongate member 110 having a first handle 114, a recess 120 located in an upper surface 121 on the elongate member 110, and a housing 130 that may be removably coupled to the recess 120. The housing 130 may include an aperture 131, a plurality of first contact strips 134 and an internal motor 132 for feeding a fishing line 151 through the aperture 131. The elongate member 110 may include a plurality of second contact strips 113. The plurality of first contact strips 134 and the plurality of second contact strips 113 may be configured to be coupled together. The apparatus 110 may additionally include a plurality of batteries 115 that is housed within a cavity 116 of the first handle 114. Finally, the apparatus 100 may include a second handle 117 that is located on an underside 122 of the elongate member 110.

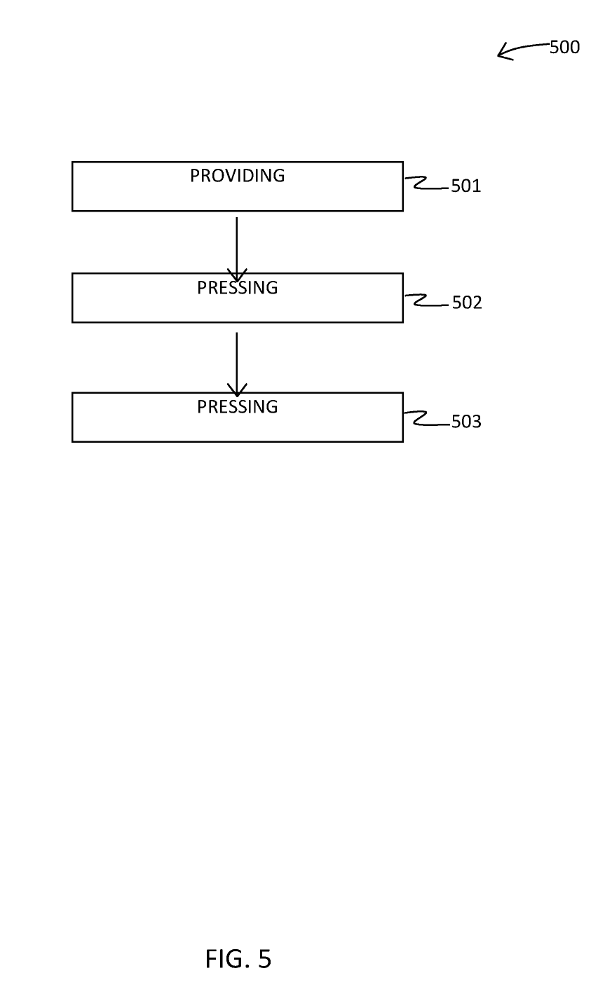

FIG. 5 is a flow diagram illustrating a method of using an automatic fishing rod 500, according to an embodiment of the present disclosure. In particular, the method of using an automatic fishing rod 500 may include one or more components or features of the apparatus 100 used for fishing as described above. As illustrated, the method of using an automatic fishing rod 500 may include the steps of: step one 501, providing a fishing rod having an elongate member that includes a plurality of second contact strips, the elongate member having a proximal end and a distal end, a recess, the recess being located on the proximal end of the elongate member, a housing including an internal motor, a plurality of first contact strips and a plurality of buttons, the housing having an aperture and being removably coupled to the recess, and wherein the plurality of first contact strips and the plurality of second contact strips are configured to be coupled together; step two 502, pressing a first of the plurality of buttons to cast a fishing line; and step three 503, pressing a second of the plurality of buttons to retrieve the fishing line.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the apparatus 100 used for fishing, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus used for fishing, the apparatus comprising:
an elongate member, the elongate member having a proximal end and a distal end;
a recess, the recess being located on the proximal end of the elongate member;
a housing, the housing having an aperture and being removably coupled to the recess;
wherein the housing includes an internal motor;
wherein the housing includes a plurality of buttons;
wherein the housing includes a plurality of first contact strips;
wherein the elongate member includes a plurality of second contact strips; and
wherein the plurality of first contact strips and the plurality of second contact strips are configured to be coupled together.

2. The apparatus of claim 1, wherein the elongate member is a fishing rod.

3. The apparatus of claim 1, wherein the housing is a fishing reel.

4. The apparatus of claim 1, wherein the proximal end includes a first handle.

5. The apparatus of claim 4, wherein the elongate member further includes a plurality of batteries.

6. The apparatus of claim 5, wherein the plurality of batteries is housed in a cavity of the handle.

7. The apparatus of claim 1, wherein the recess is located in an upper surface of the proximal end of the elongate member.

8. The apparatus of claim 2, wherein the elongate member further includes a second handle located on the proximal end of the elongate member.

9. The apparatus of claim 8, wherein the second handle is located on an underside of the proximal end of the elongate member.

10. The apparatus of claim 5, wherein the elongate member further comprises a port configured to allow charging of the batteries.

11. The apparatus of claim 1, wherein the elongate member includes a screw clamp.

12. The apparatus of claim 1, wherein the plurality of buttons comprises a first button and a second button.

13. The apparatus of claim 12, wherein the first button comprises a casting trigger configured to cast a fishing line.

14. The apparatus of claim 12, wherein the second button comprises a push button configured to retrieve a fishing line.

15. The apparatus of claim 3, wherein the fishing reel is electric.

16. The apparatus of claim 1, wherein the aperture is located on a housing-distal-end.

17. An apparatus used for fishing, the apparatus comprising:
an elongate member, the elongate member having a proximal end and a distal end;
a recess, the recess being located on the proximal end of the elongate member;
a housing, the housing having an aperture and being removably coupled to the recess;
wherein the housing includes an internal motor;
wherein the housing includes a plurality of buttons;
wherein the housing includes a plurality of first contact strips;
wherein the elongate member includes a plurality of second contact strips;
wherein the plurality of first contact strips and the plurality of second contact strips are configured to be coupled together;
wherein the elongate member is a fishing rod;
wherein the housing is a fishing reel;
wherein the proximal end includes a first handle;
wherein the elongate member further includes a plurality of batteries;
wherein the plurality of batteries is housed in a cavity of the handle;
wherein the recess is located in an upper surface of the proximal end of the elongate member;
wherein the elongate member further includes a second handle located on the proximal end of the elongate member;
wherein the second handle is located on an underside of the proximal end of the elongate member;
wherein the elongate member further comprises a port configured to allow charging of the batteries;
wherein the elongate member includes a screw clamp;
wherein the plurality of buttons comprises a first button and a second button;
wherein the first button comprises a casting trigger configured to cast a fishing line;
wherein the second button comprises a push button configured to retrieve a fishing line;
wherein the fishing reel is electric; and
wherein the aperture is located on a housing-distal-end.

18. The apparatus of claim 17, further comprising set of instructions; and
wherein the apparatus is arranged as a kit.

19. A method of using an automatic fishing rod, comprising:
providing a fishing rod having an elongate member, the elongate member having a proximal end and a distal end, a recess, the recess being located on the proximal end of the elongate member, a housing, the housing having an aperture and being removably coupled to the recess, wherein the housing includes an internal motor, wherein the housing includes a plurality of buttons, wherein the housing includes a plurality of first contact strips, wherein the elongate member includes a plurality of second contact strips, and wherein the plurality of first contact strips and the plurality of second contact strips are configured to be coupled together;
pressing a first of the plurality of buttons to cast a fishing line; and
pressing a second of the plurality of buttons to retrieve the fishing line.
